(19) United States
(12) Patent Application Publication
(10) Pub. No.: US 2020/0320109 A1
(43) Pub. Date: Oct. 8, 2020

(54) SOIL CORROSIVITY MAPPING METHOD AND APPARATUS

(71) Applicant: MATERGENICS, INC., Pittsburgh, PA (US)

(72) Inventors: Mehrooz Zamanzadeh, Pittsburgh, PA (US); Peyman Taheri Bonab, Vancouver (CA); Carolyn Tome, Pittsburgh, PA (US); Alyson Char, Vancouver (CA)

(73) Assignee: MATERGENICS, INC., Pittsburgh, PA (US)

(21) Appl. No.: 16/839,106

(22) Filed: Apr. 3, 2020

Related U.S. Application Data
(60) Provisional application No. 62/829,906, filed on Apr. 5, 2019.

(51) Int. Cl. G06F 16/29; G06F 16/2458; G01N 17/04; G06F 16/248

(52) U.S. Cl. CPC G06F 16/29; G06F 16/248; G01N 17/04; G06F 16/2458

(57) ABSTRACT

A plurality of disparate datasets is aggregated into a geodata data structure specifying a plurality of geospatial locations and a set of aspatial parameters at each geospacial location. Each aspatial parameter is combined at each geospacial location to generate a corrosivity scale parameter at each of the plurality of geospatial locations. A grid with cells representing each of the plurality of geospatial locations and each of the corresponding corrosivity scale parameters is created. The grid is stored for output of at least a portion of the plurality of geospatial locations and the corresponding corrosivity scale parameters overlaid on a geographic map. The innovation can be used in corrosion risk assessment of underground structures related to oil and gas, water/waste water and electric power transmission/distribution structures.

### CROSS REFERENCE TO RELATED APPLICATION

This application claims the benefit under 35 U.S.C. § 119(e) of co-pending U.S. Provisional Application No. 62/829,906 entitled “SOIL CORROSIVITY MAPPING METHOD AND APPARATUS” filed Apr. 5, 2019, which is incorporated herein by reference.

### BACKGROUND

Corrosion is a serious problem for outdoor structures, including pipelines, transmission and distribution structures in oil and gas, water/waste water and electric utility industries below grade tanks, and other underground facilities or assets. Corrosion is a particularly important issue when outdoor structures are placed in corrosive soils because aging metallic structures can react with such soils. Such reactions result in material loss and in the weakening of such structures, which can result in perforations, oil leaks, explosions in pressurized pipelines, and other types of failures. As a result, the need to monitor corrosion and corrosion risk of outdoor structures is very important.

Above-grade and below-grade corrosion is of particular concern for structures involving utilities, such as pipelines, water transmission and distribution structures, wastewater transmission structures, electric utility transmission and distribution systems, and telecommunication structures. Moreover, coated structures can provide additional concerns because the coatings can fail thereby hastening the failure of coated outdoor structures.

Severe below-ground corrosion is a particularly difficult problem for utility poles/towers, other related electric power transmission structures, and pipelines. Inspecting each structure for corrosion, corrosivity, and/or corrosion risk assessment is a monumental task because many of such structures can be deployed over vast territories. Accordingly, there is a need for improved tools for prioritization of corrosion inspections, predicting corrosion rate, and monitoring corrosion risk.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a plurality of disparate datasets is aggregated into a geodata data structure specifying a plurality of geospatial locations and a set of aspatial parameters at each geospacial location. Each aspatial parameter is combined at each geospacial location to generate a corrosivity scale parameter at each of the plurality of geospatial locations. A grid with cells representing each of the plurality of geospatial locations and each of the corresponding corrosivity scale parameters is created. The grid is stored for output of at least a portion of the plurality of geospatial locations and the corresponding corrosivity scale parameters overlaid on a geographic map.

In other implementations, datasets having aspatial data corresponding to a plurality of geospacial locations are imported from a plurality of data sources. The datasets are stored in a plurality of file attribute tables with the aspatial data linked to the corresponding plurality of geospacial locations within the plurality of file attribute tables. A plurality of data layers is aggregated from the plurality of file attribute tables to determine a corrosivity scale parameter at each of the plurality of geospatial locations. A grid with cells representing each of the plurality of geospatial locations and the corresponding corrosivity scale parameters is created. The grid is stored for output of at least a portion of the plurality of geospatial locations and the corresponding corrosivity scale parameters overlaid on a geographic map.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a schematic diagram of an operating environment in accordance with the subject disclosure.

FIG. 2A is an exemplary process in accordance with the subject disclosure.

FIG. 2B is an exemplary screen shot of a window from a spatial analysis and modeling tool in accordance with the subject disclosure.

FIG. 3A is a top plan view of a display device illustrating exemplary output in accordance with the subject disclosure.

FIG. 3B is another top plan view of a display device illustrating exemplary output in accordance with the subject disclosure.

FIG. 3C is another top plan view of a display device illustrating exemplary output in accordance with the subject disclosure.

FIG. 3D is another top plan view of a display device illustrating exemplary output in accordance with the subject disclosure.

FIG. 3E is another top plan view of a display device illustrating exemplary output in accordance with the subject disclosure.

FIG. 3F is another top plan view of a display device illustrating exemplary output in accordance with the subject disclosure.

FIG. 3G is another top plan view of a display device illustrating exemplary output in accordance with the subject disclosure.

FIG. 3H is another top plan view of a display device illustrating exemplary output in accordance with the subject disclosure.

FIG. 4 is another exemplary process in accordance with the subject disclosure.

FIG. 5 is a schematic diagram for a computer system for implementing the subject matter of the subject disclosure.

### DETAILED DESCRIPTION

The subject disclosure is directed to methods and apparatus for generating corrosivity maps, and, more particularly, to systems that generate soil corrosion risk assessment maps for a service territory to help asset owners identify areas of high, medium and low below-ground corrosion risks. The systems aggregate data relating to various properties of soil to identify the areas of high, medium, and low soil corrosivity. As a result, users can deploy its resources to specific areas of highest corrosion risk in a more efficient manner

The systems aggregate data from various sources of spatial and aspatial data. The system can produce corrosion maps for underground pipeline, underground tank, bottom plates of above ground storage tanks, underground portions of transmission and distribution towers and poles, galvanized anchors, piles, construction foundations that can include concrete that deteriorates in sulfate containing soil, water mains, waste water pipes, water pipes, solar farms, and other similar structures. Such systems can be an essential tool in planning, developing, and maintaining underground asset integrity and for ensuring the safety for workers and others who are in proximity of such assets.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The phrases “corrosivity map” and “corrosion risk map” shall be used interchangeably herein.

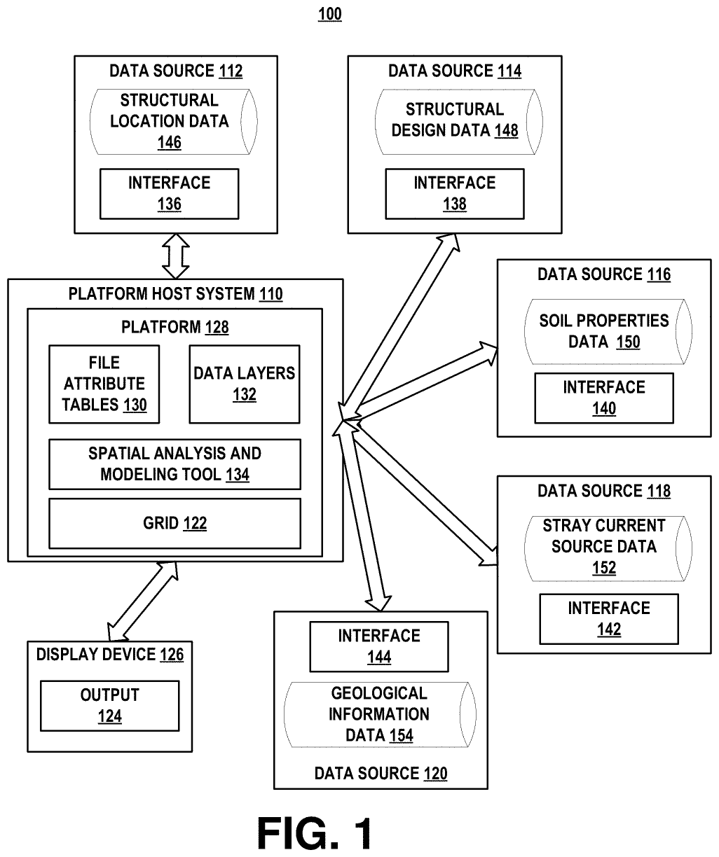

Referring to FIG. 1, various features of the subject disclosure are now described in more detail with respect to an operating environment, generally designated with the numeral 100, for generating corrosivity maps. The operating environment 100 includes a platform host system 110 that aggregates data from a variety of sources 112-120 and stores the data in a geodata data structure. The data includes geospatial locations and linked aspatial parameters. The platform host system 110 utilizes the data to generate corrosivity scale parameters at each of the geospatial locations by weighing the aspatial parameters and uses the data to create a grid 122 of cells.

The grid 122 is stored for output 124 on a display device 126 as a corrosivity map, which can identify corrosive soils and can assist in identifying hot areas of corrosion thereby reducing possible incidents and accidents. The corrosivity map represents the final product or final output. Additionally, the display device 126 can display other types of maps, so that the output 124 can be intermediate output.

The platform host system 110 can include a platform 128 that utilizes the grid 122, file attribute tables 130, data layers 132, and a spatial analysis and modeling tool 134. The platform host system 110 stores the data within the file attribute tables 130 and aggregates the data into data layers 132. The platform host system 110 assigns a weight to each of data layers 132 to form weighted data layers for generating corrosivity scale parameters linked to various locations within a predetermined geographic area. In this exemplary embodiment, the spatial analysis and modeling tool 134 can be a spatial analyst toolbox that assigns weighting to layers based upon importance.

The platform host system 110 and the platform 128 can comprise hardware, software, and data that collect, sort, analyze, and disseminate information about the Earth. The platform host system 110 and the platform 128 integrates various disciplines and technologies, such as remote sensing, cartography, surveying, and computer science. The system can assist users in finding the least corrosive sites, the most corrosive sites, access to sites, locate corrosive environments for corrosion risk mitigation.

The platform 128 can use Geographic Information System (GIS) software, such as the Aeronautical Reconnaissance Coverage Geographic Information System (ArcGIS), Google Earth, Google Maps, and AutoCAD MAP. In this exemplary embodiment, the platform 128 is ArcGIS, which represents a suite of products such as ArcMAP and Arc Catalog, which provides software tools for visualizing and analyzing data. ArcMAP can be used to display and to explore ArcGIS datasets.

The platform host system 110 communicates with the sources 112-120 through interfaces 136-144. The source 112 stores structural location data 146. The structural location data 146 includes the location of various structures that can be of interest to the user. The structures can include pipelines, structures for water transmission or distribution, wastewater transmission or distribution, electric utility transmission, electric utility distribution, telecommunication structures or other similar structures. In this exemplary embodiment, the structures can be carbon steel, weathering steel or galvanized steel poles.

The source 114 stores structural design data 148. The structural design data 148 can include structural configurations, components, materials, and related design data. In this exemplary embodiment, the structural design data can relate to the structural configuration of, the components of, the material utilized in, and other design data relating to carbon steel, weathering steel or galvanized steel poles.

The source 116 stores soil properties data 150. The soil properties data 150 can include physical and/or chemical properties of soil. Such physiochemical properties of soil can describe the corrosivity of liquid phase in soil. Other properties can include soil electrical conductivity, soil pH, and concentration of specific salts (such as chlorides, sulfates, and sulfides).

In this exemplary embodiment, the source 116 can be the Soil Survey Geographic Database (SSURGO) that is maintained by the United States Department of Agriculture. The information can be provided tabular form, which can be linked to polygon attributes/raster file over area of interest via a map unit key. The information can include chemical properties. . An exemplary file within the database is a data file entitled “chorizon”, which includes information on soil chemistry and physical properties.

The source 118 stores stray current data 152. Stray current data 152 can be determined by identifying structures that are in the vicinity of a particular geographic location that could be the source of stray currents. In this exemplary embodiment, the source of stray currents can be cathodically protected pipelines and/or equipment that discharge DC electric current into ground.

The source 120 stores geological information data 154. Geological information data 154 can be utilized to estimate the moisture content of soil and the time of wetness. The geological information data 154 can include soil type, surface topology, clay/sand/silt content, drainage capacity and texture class. The most well-known classification for soil type/texture is the United States Department of Agriculture textural classification triangle. Soil texture refers to the size distribution of soil particles, regardless of the material components. Soil categorization is made based on the relative proportions of silt, sand and clay that are main soil components with different grain size. Other exemplary sources of such data include the Department of Defense, National Resources Conservation Service, and various university databases.

It should be understood that dry soil regardless of its chemical components is not a conductive environment, so that it is not a corrosive environment. The presence of moisture or a liquid phase makes a soil environment corrosive. At the presence of such moisture, corrosive compounds/ions dissolve and move in the liquid phase of soil to facilitate corrosion reactions. Higher concentrations of corrosive ions in soil can result in soils that have a higher corrosivity.

The potential for corrosion reactions remains as long as the liquid phase is present. The potential for corrosion reactions remain when soil remains wet for a longer period of time. The time of wetness depends on the soil texture and surface topology of earth.

Soils with a high percentage of clay content are more corrosive since they can retain the moisture for a long time compared to other types of soil. In contrast, sandy soils are least corrosive due to their high drainage capacity.

It should be understood that one or more of the data sources 112-120 can communicate with the platform host system 110 over an electronic network, but such communication is not necessary for the data sources 112-120 to share information with the platform host system 110. Additionally, the platform host system 110 can communicate with the display device 126 over the network, but the use of a network is not necessary for such communication.

The electronic network can be implemented by any type of network or combination of networks including, without limitation: a wide area network (WAN) such as the Internet, a local area network (LAN), a Peer-to-Peer (P2P) network, a telephone network, a private network, a public network, a packet network, a circuit-switched network, a wired network, and/or a wireless network. Servers and workstations can communicate via networks using various communication protocols (e.g., Internet communication protocols, WAN communication protocols, LAN communications protocols, P2P protocols, telephony protocols, and/or other network communication protocols), various authentication protocols, and/or various data types (web-based data types, audio data types, video data types, image data types, messaging data types, signaling data types, and/or other data types).

The platform host system 110 can identify areas at higher risk for corrosion, which can be important when pipelines or other similar outdoor structures age. These structures can be positioned over thousands of square miles, which can result in users needing to maximize limited resources to manage corrosion issues effectively. The platform host system 110 can produce a corrosion risk assessment map for areas of high corrosion risk as output 124. Such corrosion risk assessment maps or corrosivity maps can combine various properties of soil to identify areas of high, medium, and low soil corrosivity.

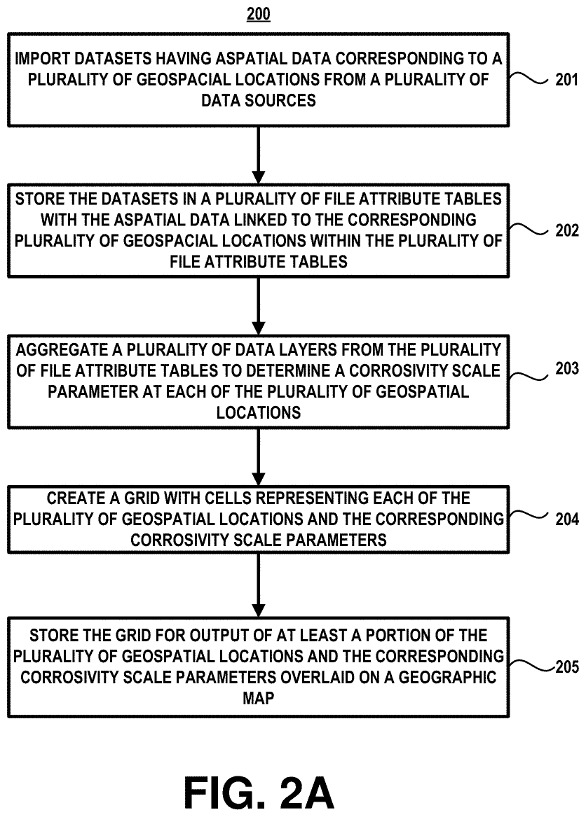

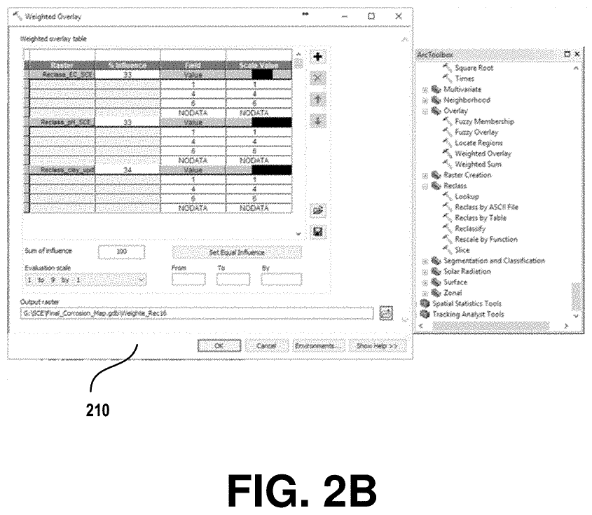

Referring to FIGS. 2A-2B with continuing reference to the foregoing figures, an exemplary process, generally designated by the numeral 200, for generating corrosivity maps is shown. In this exemplary embodiment, the process 200 can be performed by the operating environment 100 shown in FIG. 1.

At 201, datasets having aspatial data corresponding to a plurality of geospacial locations are imported from a plurality of data sources. In this exemplary embodiment, the data sources can be the sources 112-120 shown in FIG. 1. The aspatial data can include aspatial parameters, such as pH, soil resistivity, clay content, wetness, salinity, soil type, drainage, stray current source proximity, and water table corrosivity.

The data sources 112-120 can include two types of data, such as spatial data and aspatial data. Spatial data can be in the form of graphics and/or data in a map. Spatial data can include vectors (i.e., lines, polygons, points, etc.). Raster data includes gridded data, which can represent discrete objects as collections of cells and/or fields by assigning attribute value to cells.

At 202, the datasets are stored in a plurality of file attribute tables with the aspatial data linked to the corresponding plurality of geospacial locations within the plurality of file attribute tables. In this exemplary embodiment, the file attribute tables can be the file attribute tables 130 shown in FIG. 1. The file attribute tables 130 can include a polygon file attribute table, a component file attribute table, and a file attribute table that includes information from the chorizon file of the SSURGO database. The tables can be linked to an original polygon file through unique ID numbers.

At 203, a plurality of data layers is aggregated from the plurality of file attribute tables to determine a corrosivity scale parameter at each of the plurality of geospatial locations. In this exemplary embodiment, the data layers can be the data layers 132 shown in FIG. 1. The data layers 132 can include soil resistivity, salinity, pH, soil type, clay content, drainage, stray current sources, and/or water table corrosivity. Examples of stray current sources include gas pipelines in close proximity

In some exemplary embodiments, the aspatial parameters are combined to generate each corrosivity scale parameter using a predetermined formula. In other exemplary embodiments, the system iterates through the geodata data structure to assign weights to each aspatial parameter at each geospacial location and generates a corrosivity scale parameter at each of the plurality of geospatial locations based upon the weight of each aspatial parameter at each of the plurality of geospatial locations.

The weights can be assigned using the spatial analysis and modeling tool 134. The spatial analysis and modeling tool 134 can assign a weight of 35% for electrical conductivity, 25% for pH, 15% for clay content, 10% for drainage class, and 15% for proximity to stray current sources. An exemplary screen shot of a window 210 from the spatial analysis and modeling tool 134 is shown in FIG. 2B.

The data layers 132 are converted into weighted data layers that are defined on a common scale. The common scale can be a dimensionless scale of 1-9 with 1-3 representing the least corrosive, 4-6 representing moderately corrosive, and 7-9 representing the most corrosive. The platform 128 shown in FIG. 1 can identify the various layers as necessary layers and unnecessary layers.

At 204, a grid with cells representing each of the plurality of geospatial locations and the corresponding corrosivity scale parameters is created. In this exemplary embodiment, the grid can be the grid 122 shown in FIG. 1.

At 205, the grid is stored for output of at least a portion of the plurality of geospatial locations and the corresponding corrosivity scale parameters overlaid on a geographic map. In this exemplary embodiment, the output can be the output 124 shown in FIG. 1. The output 124 can be displayed on the display device 126 shown in FIG. 1.

### Exemplary Output

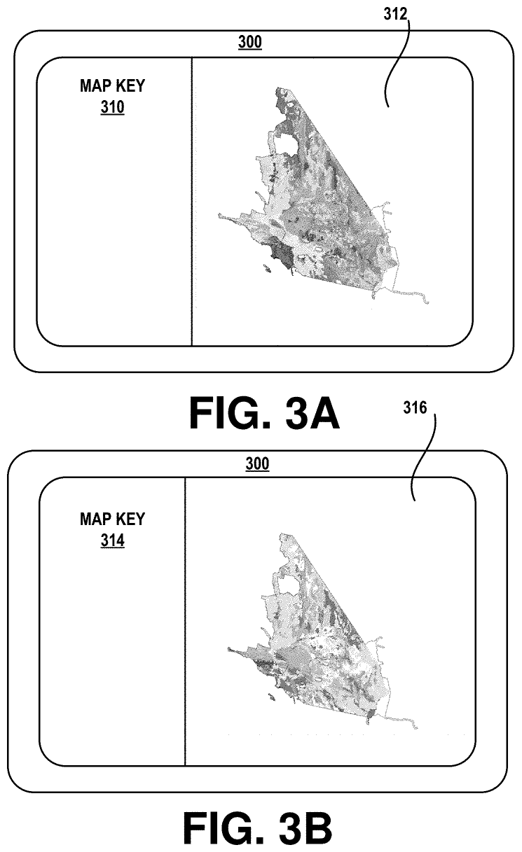

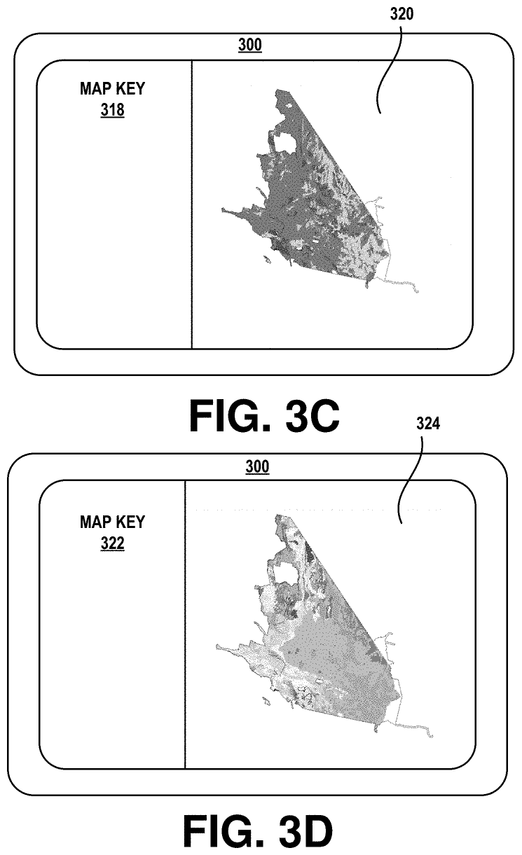

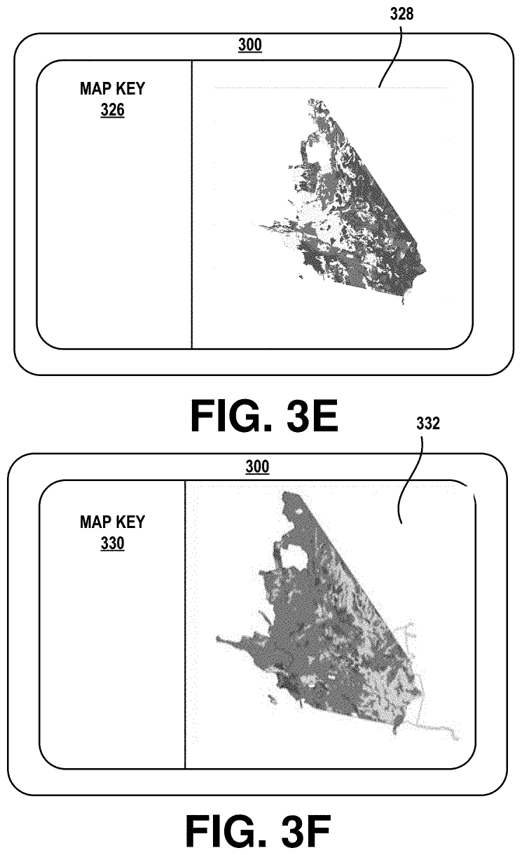

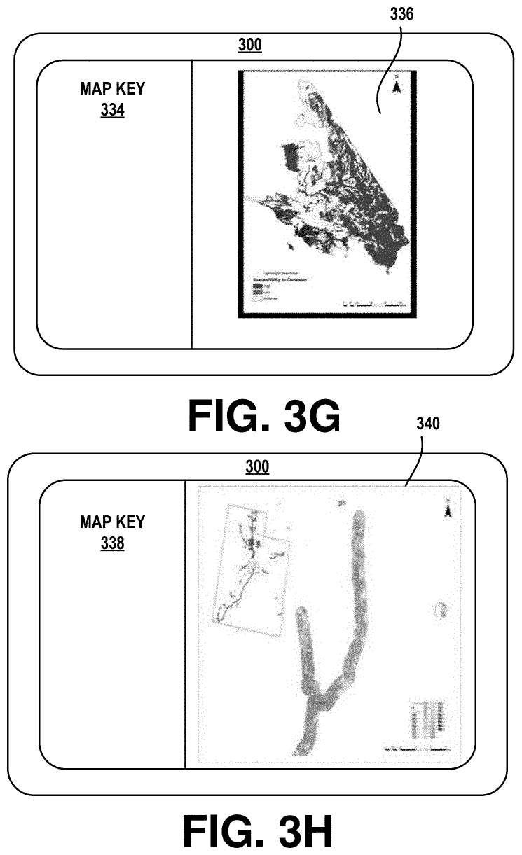

Referring to FIGS. 3A-3H with continuing reference to the foregoing figures, a display device, generally designated with the numeral 300, which is configured to display exemplary output in accordance with the subject disclosure, is shown. In this exemplary embodiment, the display device 300 can be the display device 126 shown in FIG. 1.

As shown in FIG. 3A, the display device 300 can display a map key 310 and exemplary output 312. The exemplary output 312 includes a clay content map. The exemplary output 312 can represent intermediate output representing one of the data layers 132 shown in FIG. 1 and produced at Step 203 shown in FIG. 2A.

The clay content map can illustrate clay content percentages at different geographic locations within a geographic region. Clay content is relevant in determining soil corrosivity because soils with high clay content correspond to more corrosive soils. Clay soils have a high capacity to retain water and/or moisture. A related parameter, the time of wetness, increases in soils as clay content increases.

As shown in FIG. 3B, the display device 300 can display a map key 314 and exemplary output 316. The exemplary output 316 includes a sand content map. The exemplary output 312 can represent intermediate output representing one of the data layers 132 shown in FIG. 1 and produced at Step 203 shown in FIG. 2A.

The sand content map can illustrate sand content percentages at different geographic locations within a geographic region. Sand content is relevant in determining soil corrosivity because soils with high sand content correspond to less corrosive soil. Sandy soils have a low capacity to retain water/moisture. The time of wetness decreases in soils as sand content increases.

As shown in FIG. 3C, the display device 300 can display a map key 318 and exemplary output 320. The exemplary output 320 includes a soil resistivity map. The exemplary output 312 can represent intermediate output representing one of the data layers 132 shown in FIG. 1 and produced at Step 203 shown in FIG. 2A. Soil resistivity can be displayed in ohm-cm units. Soil resistivity, as well as the corresponding parameter soil conductivity, can correlate with soil corrosivity.

As shown in FIG. 3D, the display device 300 can display a map key 322 and exemplary output 324. The exemplary output 324 includes a pH map. The exemplary output 312 can represent intermediate output representing one of the data layers 132 shown in FIG. 1 and produced at Step 203 shown in FIG. 2A.

As shown in FIG. 3E, the display device 300 can display a map key 326 and exemplary output 328. The exemplary output 328 includes a corrosivity map. The exemplary output 328 can correspond to the output 124 shown in FIG. 1 and produced in Step 206 shown in FIG. 2A. In this exemplary example, the exemplary output 328 displays regions within the least corrosive range (i.e., 1-3) in green, within the moderately corrosive range (i.e., 4-6) in yellow, and within the highly corrosive range (i.e., 7-9) in red.

As shown in FIG. 3F, the display device 300 can display a map key 330 and exemplary output 332. The exemplary output 332 includes another corrosivity map. The exemplary output 328 can correspond to the output 124 shown in FIG. 1 and produced in Step 206 shown in FIG. 2A.

As shown in FIG. 3G, the display device 300 can display a map key 334 and exemplary output 336. The exemplary output 336 includes a susceptibility to corrosion map. The exemplary output 336 can correspond to the output 124 shown in FIG. 1 and produced in Step 206 shown in FIG. 2A

As shown in FIG. 3H, the display device 300 can display a map key 338 and exemplary output 340. The exemplary output 340 includes a zoomed in view of a portion of another corrosivity map. The exemplary output 340 can correspond to the output 124 shown in FIG. 1 and produced in Step 206 shown in FIG. 2A.

### Exemplary Processes

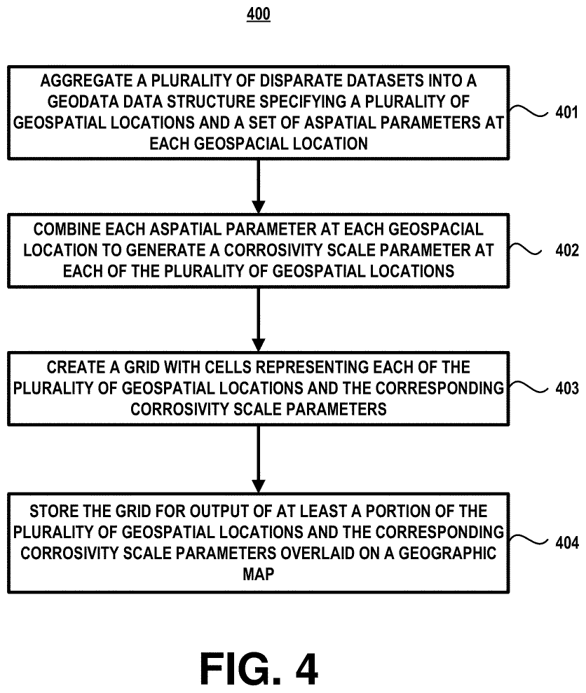

Referring to FIG. 4 with continuing reference to the foregoing figures, an exemplary process, generally designated by the numeral 400, for generating corrosivity maps is shown. In this exemplary embodiment, the process 400 can be performed by the operating environment 100 shown in FIG. 1.

At 401, a plurality of disparate datasets is aggregated into a geodata data structure specifying a plurality of geospatial locations and a set of aspatial parameters at each geospacial location. In this exemplary embodiment, the disparate datasets are stored with data sources 112-120 shown in FIG. 1.

At 402, each aspatial parameter is combined at each geospacial location to generate a corrosivity scale parameter at each of the plurality of geospatial locations, In some embodiments, the aspatial parameters are combined to determine each corrosivity scale parameter using a predetermined formula. In other embodiments, Step 402 is performed by assigning a weight to each of the plurality of data layers to form a plurality of weighted data layers and combining the weighted data layers to generate a corrosivity scale parameter at each of the plurality of geospatial locations.

The platform 128 shown in FIG. 1 iterates through the geodata data structure. The spatial analysis and planning tool 134 shown in FIG. 1 can assign the weights to each aspatial parameter. The platform 128 shown in FIG. 1 can generate the corrosivity scale parameter.

At 403, a grid with cells representing each of the plurality of geospatial locations and the corresponding corrosivity scale parameters is created. In this exemplary embodiment, the platform 128 creates the grid 122 with cells shown in FIG. 1.

At 404, the grid is stored for output of at least a portion of the plurality of geospatial locations and the corresponding corrosivity scale parameters overlaid on a geographic map. In this exemplary embodiment, the platform 128 stores the grid 122 for output 124 on the display device 126 shown in FIG. 1.

### Exemplary Computer Systems

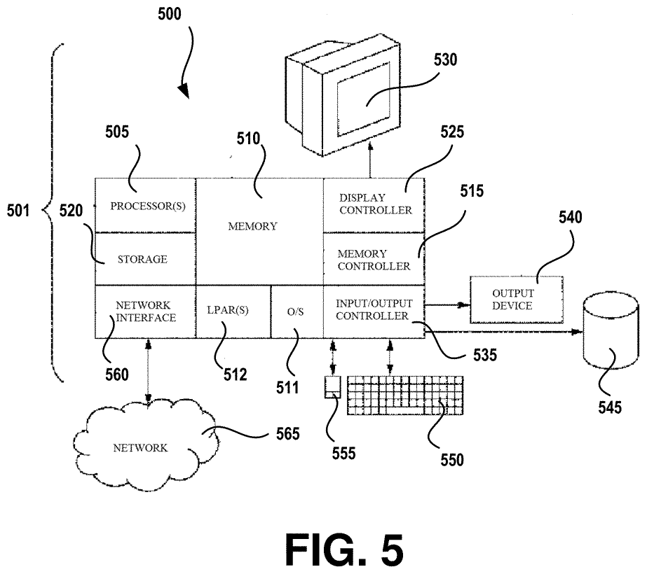

Referring now to FIG. 5 with continuing reference to the forgoing figures, a computer system for generating a corrosivity map is generally shown according to one or more embodiments. The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 500 therefore can include general-purpose computer or mainframe 501 capable of running multiple instances of an O/S simultaneously.

In an exemplary embodiment, in terms of hardware architecture, as shown in FIG. 5, the computer 501 includes one or more processors 505, memory 510 coupled to a memory controller 515, and one or more input and/or output (I/O) devices 540, 545 (or peripherals) that are communicatively coupled via a local input/output controller 535. The input/output controller 535 can be, for example but not limited to, one or more buses or other wired or wireless connections, as is known in the art. The input/output controller 535 can have additional elements, which are omitted for simplicity, such as controllers, buffers (caches), drivers, repeaters, and receivers, to enable communications. Further, the local interface can include address, control, and/or data connections to enable appropriate communications among the aforementioned components. The input/output controller 535 can include a plurality of sub-channels configured to access the output devices 540 and 545. The sub-channels can include fiber-optic communications ports.

The processor 505 is a hardware device for executing software, particularly that stored in storage 520, such as cache storage, or memory 510. The processor 505 can be any custom made or commercially available processor, a central processing unit (CPU), an auxiliary processor among several processors associated with the computer 501, a semiconductor based microprocessor (in the form of a microchip or chip set), a macroprocessor, or generally any device for executing instructions.

The memory 510 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 can incorporate electronic, magnetic, optical, and/or other types of storage media. Note that the memory 510 can have a distributed architecture, where various components are situated remote from one another, but can be accessed by the processor 505.

The instructions in memory 510 can include one or more separate programs, each of which comprises an ordered listing of executable instructions for implementing logical functions. In the example of FIG. 5, the instructions in the memory 510 a suitable operating system (OS) 511. The operating system 511 essentially controls the execution of other computer programs and provides scheduling, input-output control, file and data management, memory management, and communication control and related services. In accordance with one or more embodiments, the memory 510 and/or an I/O device 545 can be used to store the file attribute tables 130 and the data layers 132 shown in FIG. 1.

The memory 510 can include multiple logical partitions (LPARs) 512, each running an instance of an operating system. The LPARs 512 can be managed by a hypervisor, which can be a program stored in memory 510 and executed by the processor 505.

In an exemplary embodiment, a conventional keyboard 550 and mouse 555 can be coupled to the input/output controller 535. Other output devices such as the I/O devices 540, 545 can include input devices, for example but not limited to a printer, a scanner, microphone, and the like. Finally, the I/O devices 540, 545 can further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 500 can further include a display controller 525 coupled to a display 530. In an exemplary embodiment, the system 500 can further include a network interface 560 for coupling to a network 565. The network 565 can be an IP-based network for communication between the computer 501 and any external server, client and the like via a broadband connection. The network 565 transmits and receives data between the computer 501 and external systems. In an exemplary embodiment, network 565 can be a managed IP network administered by a service provider. The network 565 can be implemented in a wireless fashion, e.g., using wireless protocols and technologies, such as WiFi, WiMax, etc. The network 565 can also be a packet-switched network such as a local area network, wide area network, metropolitan area network, Internet network, or other similar type of network environment. The network 565 can be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 501 is a PC, workstation, intelligent device or the like, the instructions in the memory 510 can further include a basic input output system (BIOS) (omitted for simplicity). The BIOS is a set of essential software routines that initialize and test hardware at startup, start the OS 511, and support the transfer of data among the hardware devices. The BIOS is stored in ROM so that the BIOS can be executed when the computer 501 is activated.

When the computer 501 is in operation, the processor 505 is configured to execute instructions stored within the memory 510, to communicate data to and from the memory 510, and to generally control operations of the computer 501 pursuant to the instructions.

In accordance with one or more embodiments described herein, the computer 501 can implement and/or perform the disclosed subject matter. As shown, computer 501 can include instructions in memory 510 for performing Steps 201-206 shown in FIG. 2A and/or Steps 401-406 shown in FIG. 4. The platform host system 110 shown in FIG. 1 can be implemented as the computer 501 shown in FIG. 5 with the display device 126 being implemented as the display 530 shown in FIG. 5.

The disclosed subject matter can be implemented as a system, a method, and/or a computer program product at any possible technical detail level of integration. The computer program product can include a computer readable storage medium (or media) having computer readable program instructions thereon for causing a processor to carry out embodiments and features of the subject disclosure.

The system can be implemented within a cloud environment. Cloud environments can be provided by a cloud services provider (i.e., “the cloud”). In such cloud environments, data resources can be abstracted among or across one or more computers and/or computer networks that make up the cloud. Examples of cloud computing environments include S3 by Amazon.com.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to exploit features of the present disclosure.

Embodiments and features of the subject disclosure are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the subject disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Supported Features and Embodiments

The detailed description provided above in connection with the appended drawings explicitly describes and supports various features of systems and methods for generating corrosivity maps. By way of illustration and not limitation, supported embodiments include a computer-implemented method comprising: aggregating a plurality of disparate datasets into a geodata data structure specifying a plurality of geospatial locations and a set of aspatial parameters at each geospacial location, combining each aspatial parameter at each geospacial location to generate a corrosivity scale parameter at each of the plurality of geospatial locations, creating a grid with cells representing each of the plurality of geospatial locations and each of the corresponding corrosivity scale parameters, and storing the grid for output of at least a portion of the plurality of geospatial locations and the corresponding corrosivity scale parameters overlaid on a geographic map. Supported embodiments include the foregoing computer-implemented method, wherein the geodata data structure is selected from the group consisting of a database, a geodatabase, a shapefile, coverage, a raster image, a dbf table and a spreadsheet.

Supported embodiments include any of the foregoing computer-implemented methods, wherein the corrosivity scale parameter is a soil corrosivity scale parameter.

Supported embodiments include any of the foregoing computer-implemented methods, wherein the aspatial parameters include pH, soil resistivity, clay content, wetness, and salinity.

Supported embodiments include any of the foregoing computer-implemented methods, wherein the aspatial parameters include soil type, drainage, stray current source proximity, and water table corrosivity.

Supported embodiments include any of the foregoing computer-implemented methods, wherein the plurality of disparate datasets include structural location, structural design data, soil properties, geological information, and stray current source.

Supported embodiments include any of the foregoing computer-implemented methods, wherein the plurality of disparate datasets are stored in data layers.

Supported embodiments include any of the foregoing computer-implemented methods, wherein the plurality of disparate datasets are stored on a server and accessed over a network.

Supported embodiments include any of the foregoing computer-implemented methods, wherein the aspatial parameters are combined to generate each corrosivity scale parameter using a predetermined formula.

Supported embodiments include any of the foregoing computer-implemented methods, wherein the combining step includes: iterating through the geodata data structure to assign weights to each aspatial parameter at each geospacial location, and generating a corrosivity scale parameter at each of the plurality of geospatial locations based upon the weight of each aspatial parameter at each of the plurality of geospatial locations.

Supported embodiments include an apparatus, a computer-readable storage medium, a system, a computer program product and/or means for implementing any of the foregoing computer-implemented methods or portions thereof.

Supported embodiments include a system comprising: a memory having computer readable instructions; and a processor for executing the computer readable instructions, the computer readable instructions including: a memory having computer readable instructions; and a processor for executing the computer readable instructions, the computer readable instructions including: combining each aspatial parameter at each geospacial location to generate a corrosivity scale parameter at each of the plurality of geospatial locations, generating a corrosivity scale parameter at each of the plurality of geospatial locations based upon the weight of each aspatial parameter at each of the plurality of geospatial locations, creating a grid with cells representing each of the plurality of geospatial locations and the corresponding corrosivity scale parameters, and storing the grid for output of at least a portion of the plurality of geospatial locations and the corresponding corrosivity scale parameters overlaid on a geographic map.

Supported embodiments include the foregoing system, wherein the geodata data structure is selected from the group consisting of a database, a geodatabase, a shapefile, coverage, a raster image, a dbf table and a spreadsheet.

Supported embodiments include any of the foregoing systems, wherein the corrosivity scale parameter is a soil corrosivity scale parameter.

Supported embodiments include any of the foregoing systems, wherein the aspatial parameters include pH, soil resistivity, clay content, wetness, salinity, soil type, drainage, stray current source proximity, and water table corrosivity.

Supported embodiments include any of the foregoing systems, wherein the plurality of disparate datasets include structural location data, structural design data, soil property data, geological data, and stray current source data.

Supported embodiments include any of the foregoing systems, wherein the plurality of disparate datasets are stored in data layers

Supported embodiments include any of the foregoing systems, wherein the plurality of disparate datasets are stored on a server and are accessed over a network.

Supported embodiments include any of the foregoing systems, wherein the aspatial parameters are combined to generate each corrosivity scale parameter using a predetermined formula.

Supported embodiments include any of the foregoing systems, wherein the computer readable instructions include instructions for: iterating through the geodata data structure to assign weights to each aspatial parameter at each geospacial location, and generating a corrosivity scale parameter at each of the plurality of geospatial locations based upon the weight of each aspatial parameter at each of the plurality of geospatial locations.

Supported embodiments include an apparatus, a computer-readable storage medium, a computer-implemented method, a computer program product and/or means for implementing any of the foregoing systems or portions thereof.

Supported embodiments include a computer program product comprising a non-transitory computer readable storage medium having program instructions embodied therewith, the program instructions executable by processing circuitry to cause the processing circuitry to perform: aggregating a plurality of disparate datasets into a geodata data structure specifying a plurality of geospatial locations and a set of aspatial parameters at each geospacial location, combining each aspatial parameter at each geospacial location to generate a corrosivity scale parameter at each of the plurality of geospatial locations, creating a grid with cells representing each of the plurality of geospatial locations and each of the corresponding corrosivity scale parameters, and storing the grid for output of at least a portion of the plurality of geospatial locations and the corresponding corrosivity scale parameters overlaid on a geographic map.

Supported embodiments include the foregoing computer program product, wherein the geodata data structure is selected from the group consisting of a database, a geodatabase, a shapefile, coverage, a raster image, a dbf table and a spreadsheet.

Supported embodiments include any of the foregoing computer program products, wherein the aspatial parameters include pH, soil resistivity, clay content, wetness, salinity, soil type, drainage, stray current source proximity, and water table corrosivity.

Supported embodiments include any of the foregoing computer program products, wherein the plurality of disparate datasets include structural location data, structural design data, soil property data, geological data, and stray current source location data.

Supported embodiments include any of the foregoing computer program products, wherein the plurality of disparate datasets are stored in data layers on a server and are accessed over a network.

Supported embodiments include an apparatus, a computer-readable storage medium, a computer-implemented method, a system and/or means for implementing any of the foregoing a computer program products or portions thereof.

Supported embodiments include a computer-implemented method comprising: importing datasets having aspatial data corresponding to a plurality of geospacial locations from a plurality of data sources, storing the datasets in a plurality of file attribute tables with the aspatial data linked to the corresponding plurality of geospacial locations within the plurality of file attribute tables, aggregating a plurality of data layers from the plurality of file attribute tables to determine a corrosivity scale parameter at each of the plurality of geospatial locations, creating a grid with cells representing each of the plurality of geospatial locations and the corresponding corrosivity scale parameters, and storing the grid for output of at least a portion of the plurality of geospatial locations and the corresponding corrosivity scale parameters overlaid on a geographic map.

Supported embodiments include the foregoing computer-implemented method, wherein the corrosivity scale parameter is a soil corrosivity scale parameter.

Supported embodiments include any of the foregoing computer-implemented methods, wherein the aspatial data include pH, soil resistivity, clay content, wetness, and salinity.

Supported embodiments include any of the foregoing computer-implemented methods, wherein the aspatial data include soil type, drainage, stray current source proximity, and water table corrosivity.

Supported embodiments include any of the foregoing computer-implemented methods, wherein the assigning step is performed by a spatial analysis and modeling tool.

Supported embodiments include any of the foregoing computer-implemented methods, wherein the aspatial parameters are combined to determine each corrosivity scale parameter using a predetermined formula.

Supported embodiments include any of the foregoing computer-implemented methods, wherein the aggregating step includes: assigning a weight to each of the plurality of data layers to form a plurality of weighted data layers, and combining the weighted data layers to generate a corrosivity scale parameter at each of the plurality of geospatial locations.

Supported embodiments include an apparatus, a computer-readable storage medium, a system, a computer program product and/or means for implementing any of the foregoing computer-implemented methods or portions thereof.

Supported embodiments include a system comprising: a memory having computer readable instructions; and a processor for executing the computer readable instructions, the computer readable instructions including: a memory having computer readable instructions; and a processor for executing the computer readable instructions, the computer readable instructions including: storing the datasets in a plurality of file attribute tables with the aspatial data linked to the corresponding plurality of geospacial locations within the plurality of file attribute tables, aggregating a plurality of data layers from the plurality of file attribute tables to determine a corrosivity scale parameter at each of the plurality of geospatial locations, creating a grid with cells representing each of the plurality of geospatial locations and the corresponding corrosivity scale parameters, and storing the grid for output of at least a portion of the plurality of geospatial locations and the corresponding corrosivity scale parameters overlaid on a geographic map.

Supported embodiments include the foregoing system, wherein the corrosivity scale parameter is a soil corrosivity scale parameter.

Supported embodiments include any of the foregoing systems, wherein the aspatial data include pH, soil resistivity, clay content, wetness, and salinity.

Supported embodiments include any of the foregoing systems, wherein the aspatial data include soil type, drainage, stray current source proximity, and water table corrosivity.

Supported embodiments include any of the foregoing systems, wherein the system includes a computer-implemented spatial analysis and modeling tool for assigning a weight to each of the plurality of data layers to form a plurality of weighted data layers.

Supported embodiments include any of the foregoing systems, wherein the aspatial parameters are combined to determine each corrosivity scale parameter using a predetermined formula.

Supported embodiments include any of the foregoing systems, wherein computer readable instructions include instructions for: assigning a weight to each of the plurality of data layers to form a plurality of weighted data layers, and combining the weighted data layers to generate a corrosivity scale parameter at each of the plurality of geospatial locations.

Supported embodiments include an apparatus, a computer-readable storage medium, a computer-implemented method, a computer program product and/or means for implementing any of the foregoing systems or portions thereof.

Supported embodiments include a computer program product comprising a non-transitory computer readable storage medium having program instructions embodied therewith, the program instructions executable by processing circuitry to cause the processing circuitry to perform: storing the datasets in a plurality of file attribute tables with the aspatial data linked to the corresponding plurality of geospacial locations within the plurality of file attribute tables, aggregating a plurality of data layers from the plurality of file attribute tables to determine a corrosivity scale parameter at each of the plurality of geospatial locations, creating a grid with cells representing each of the plurality of geospatial locations and the corresponding corrosivity scale parameters, and storing the grid for output of at least a portion of the plurality of geospatial locations and the corresponding corrosivity scale parameters overlaid on a geographic map.

Supported embodiments include the foregoing computer program product, wherein the corrosivity scale parameter is a soil corrosivity scale parameter.

Supported embodiments include any of the foregoing computer program products, wherein the aspatial data include pH, soil resistivity, clay content, wetness, and salinity.

Supported embodiments include any of the foregoing computer program products, wherein the aspatial data include soil type, drainage, stray current source proximity, and water table corrosivity.

Supported embodiments include any of the foregoing computer program products, wherein the assigning instructions are implemented by a spatial analysis and modeling tool.

Supported embodiments include an apparatus, a computer-readable storage medium, a computer-implemented method, a system and/or means for implementing any of the foregoing a computer program products or portions thereof.

Supported embodiments can provide various attendant and/or technical advantages in terms of an instrumentality that produces a corrosion risk assessment map of a service territory that identifies areas of high, medium and low corrosion risks. The corrosion risk assessment map or corrosivity map can combine various properties of soil to identify areas of high, medium, and low soil corrosivity.

Supported embodiments include instrumentalities that can produce corrosivity maps that cover thousands of square miles of territory for utilities and other similar entities.

Supported embodiments include instrumentalities that provide users with the ability to maximize limited resources and to effectively manage below-ground corrosion issues.

Supported embodiments include instrumentalities that combine various properties of soil to identify areas of high, medium, and low soil corrosivity.

Supported embodiments include instrumentalities that provide companies with the ability to deploy resources in the most efficient manner and to specific areas of identifiable high corrosion risk.

Supported embodiments include instrumentalities that produce corrosivity maps that can be used for corrosion risk assessment, DC/AC interference risk and mitigation, identifying areas that shielding/coating dis-bondment, which can potentially cause localized corrosion, leaks, and, even, explosions.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A computer-implemented method comprising:
aggregating a plurality of disparate datasets into a geodata data structure specifying a plurality of geospatial locations and a set of aspatial parameters at each geospacial location,
combining each aspatial parameter at each geospacial location to generate a corrosivity scale parameter at each of the plurality of geospatial locations,
creating a grid with cells representing each of the plurality of geospatial locations and each of the corresponding corrosivity scale parameters, and
storing the grid for output of at least a portion of the plurality of geospatial locations and the corresponding corrosivity scale parameters overlaid on a geographic map.

2. The computer-implemented method of claim 1, wherein the geodata data structure is selected from the group consisting of a database, a geodatabase, a shapefile, coverage, a raster image, a dbf table and a spreadsheet.

3. The computer-implemented method of claim 1, wherein the corrosivity scale parameter is a soil corrosivity scale parameter.

4. The computer-implemented method of claim 3, wherein the aspatial parameters include pH, soil resistivity, clay content, wetness, and salinity.

5. The computer-implemented method of claim 4, wherein the aspatial parameters include soil type, drainage, stray current source proximity, and water table corrosivity.

6. The computer-implemented method of claim 1, wherein the plurality of disparate datasets include structural location, structural design data, soil properties, geological information, and stray current source.

7. The computer-implemented method of claim 6, wherein the plurality of disparate datasets are stored in data layers.

8. The computer-implemented method of claim 7, wherein the plurality of disparate datasets are stored on a server and accessed over a network.

9. The computer-implemented method of claim 1, wherein the aspatial parameters are combined to generate each corrosivity scale parameter using a predetermined formula.

10. The computer-implemented method of claim 1, wherein the combining step includes:
iterating through the geodata data structure to assign weights to each aspatial parameter at each geospacial location, and
generating a corrosivity scale parameter at each of the plurality of geospatial locations based upon the weight of each aspatial parameter at each of the plurality of geospatial locations.

11. A system comprising:
a memory having computer readable instructions; and a processor for executing the computer readable instructions, the computer readable instructions including:
combining each aspatial parameter at each geospacial location to generate a corrosivity scale parameter at each of the plurality of geospatial locations, generating a corrosivity scale parameter at each of the plurality of geospatial locations based upon the weight of each aspatial parameter at each of the plurality of geospatial locations,
creating a grid with cells representing each of the plurality of geospatial locations and the corresponding corrosivity scale parameters, and
storing the grid for output of at least a portion of the plurality of geospatial locations and the corresponding corrosivity scale parameters overlaid on a geographic map.

12. The system of claim 11, wherein the geodata data structure is selected from the group consisting of a database, a geodatabase, a shapefile, coverage, a raster image, a dbf table and a spreadsheet.

13. The system of claim 11, wherein the corrosivity scale parameter is a soil corrosivity scale parameter.

14. The system of claim 13, wherein the aspatial parameters include pH, soil resistivity, clay content, wetness, salinity, soil type, drainage, stray current source proximity, and water table corrosivity.

15. The system of claim 11, wherein the plurality of disparate datasets include structural location data, structural design data, soil property data, geological data, and stray current source data.

16. The system of claim 15, wherein the plurality of disparate datasets are stored in data layers.

17. The system of claim 16, wherein the plurality of disparate datasets are stored on a server and are accessed over a network.

18. The system of claim 11, wherein the aspatial parameters are combined to generate each corrosivity scale parameter using a predetermined formula.

19. The system of claim 11, wherein the computer readable instructions include instructions for:
iterating through the geodata data structure to assign weights to each aspatial parameter at each geospacial location, and
generating a corrosivity scale parameter at each of the plurality of geospatial locations based upon the weight of each aspatial parameter at each of the plurality of geospatial locations.

20. A computer program product comprising a non-transitory computer readable storage medium having program instructions embodied therewith, the program instructions executable by processing circuitry to cause the processing circuitry to perform:
aggregating a plurality of disparate datasets into a geodata data structure specifying a plurality of geospatial locations and a set of aspatial parameters at each geospacial location,
combining each aspatial parameter at each geospacial location to generate a corrosivity scale parameter at each of the plurality of geospatial locations,
creating a grid with cells representing each of the plurality of geospatial locations and each of the corresponding corrosivity scale parameters, and
storing the grid for output of at least a portion of the plurality of geospatial locations and the corresponding corrosivity scale parameters overlaid on a geographic map.
